(19) United States
(12) Patent Application Publication
(10) Pub. No.: US 2026/0296538 A1
(43) Pub. Date: Oct. 1, 2026

(54) AN ELECTRO-HYDRAULIC STEERING SYSTEM FOR A VEHICLE AND A METHOD FOR LIMITING THE STEERING ANGLE OF THE ELECTRO-HYDRAULIC STEERING SYSTEM

(71) Applicant: AGCO International GmbH, Neuhausen Am Rheinfall (CH)

(72) Inventors: Oliver KAUFMANN, Marktoberdorf (DE); Werner UNSINN, Marktoberdorf (DE); Thomas MARTIN, Marktoberdorf (DE); Stefan PRESTEL, Marktoberdorf (DE)

(21) Appl. No.: 19/483,420

(22) PCT Filed: Apr. 11, 2024
(86) PCT No.: PCT/IB2024/053531

§ 371 Date: Nov. 11, 2025

(30) Foreign Application Priority Data
May 12, 2023 (GB) 2307107.9

(51) Int. Cl. B62D 6/02; B62D 5/093; B62D 6/00

(52) U.S. Cl. CPC B62D 6/02; B62D 5/093; B62D 6/002

(57) ABSTRACT

An electro-hydraulic steering system (2) for a vehicle has a control unit (24) configured to carry out a method for limiting the steering angle of the electro-hydraulic steering system (2) by method steps for estimating a driving speed of the vehicle (1), determining a maximum steering angle threshold (αmax) in dependence of the estimated driving speed of the vehicle (1), determining an automatic steering angle (αG) in response to an automatic steering demand, controlling a fluid flow provided by an electro-hydraulic valve (29) of the electro-hydraulic steering system (2) for controlling a hydraulic steering actuator (14, 15) connected with a steered wheel (17, 19) to adjust a steering angle (α18) of the steered wheel (17, 19) according to the automatic steering angle (αG) and limiting the automatic steering angle (αG) to the maximum steering angle threshold (αmax).

### FIELD

The present disclosure relates generally to an electro-hydraulic steering system for a vehicle to be steered automatically and a method for limiting the steering angle of the electro-hydraulic steering system.

### BACKGROUND

Autonomous vehicles are configured to control driving functionalities automatically. While driving, an autonomous vehicle may change automatically the driving direction by means of an automatic steering action. The autonomous vehicle may control a steering system, for example an electro-hydraulic steering system, to adjust the steering angle of the steered wheels. The steering angle should be adjusted correspondent to the vehicle driving speed since a too great steering angle in case of higher driving speeds may cause a driving instability of the vehicle.

### BRIEF SUMMARY

It is an objective to provide an electro-hydraulic steering system and a method to control the steering system to ensure vehicle stability when the vehicle is driven and steered automatically. The steering system shall be configured to ensure vehicle stability also in case of a lost vehicle speed signal.

According to an aspect of the invention there is provided an electro-hydraulic steering system for a vehicle comprising a steered wheel with an adjustable steering angle, a steering wheel for demanding a manual steering angle based on a turning angle of the steering wheel, a control unit connected with an electro-hydraulic valve, wherein the control unit is configured to estimate a driving speed of the vehicle, determine a maximum steering angle threshold in dependence of the estimated driving speed of the vehicle, determine an automatic steering angle in response to an automatic steering demand, control a fluid flow provided by the electro-hydraulic valve for controlling a hydraulic steering actuator connected with the steered wheel to adjust the steering angle of the steered wheel according to the automatic steering angle wherein the automatic steering angle is limited to the maximum steering angle threshold.

The electro-hydraulic steering system may be integrated in a vehicle, for example an agricultural vehicle such as a tractor, a combine, a harvester, etc., or any other type of a vehicle. An operator may control the vehicle manually and may adjust the driving direction by controlling the steering wheel. Additionally, the vehicle may drive autonomously and may change the driving direction automatically by controlling the electro-hydraulic valve of the electro-hydraulic steering system according to the automatic steering demand determined by the control unit. The hydraulic steering actuator controlled by the electro-hydraulic valve may comprise a double acting hydraulic cylinder comprising a piston controllable in a left and in a right direction for turning the steered wheels accordingly.

The maximum steering angle threshold may be set to a value that ensures vehicle stability in dependence of the estimated driving speed. I. e., the maximum steering angle threshold may be higher if the estimated driving speed is lower for allowing greater steering angles of the steered wheel and vice versa. The automatic steering angle is limited by the maximum steering angle threshold. Thus, the automatic steering angle will not exceed the maximum steering angle threshold and will not be too great to cause a driving instability. Since the control unit is configured to estimate the driving speed, the maximum steering angle threshold can be determined by the control unit without a direct measurement of the driving speed or also in case of a loss of a driving speed signal provided by a speed sensor.

The electro-hydraulic steering system may comprise at least one sensor other than a speed sensor for estimating the driving speed of the vehicle.

For example, the electro-hydraulic steering system may comprise two or more dissimilar redundant sensors other than a speed sensor. Hence, if one sensor fails due to an error, the other sensor may not be affected by the same error.

The at least one sensor may be a wheel angle sensor for determining the steering angle of the steered wheel.

Thus, the at least one sensor is different to a speed sensor for measuring the driving speed of the vehicle. But the control unit may process the steering angle determined by the wheel angle sensor for estimating the driving speed of the vehicle.

The control unit may be configured to determine the steering angle of the steered wheel over a period of time and to estimate the driving speed of the vehicle wherein the driving speed of the vehicle may be the higher, the smaller the steering angle of the steered wheel over a period of time may be.

The period of time may be any time interval. For example, the period of time may delay more than 5 and less than 8 seconds, e. g. for a manual steering operation. In case of an automatic steering operation, the period of time may be a little bit greater compared to a manual operation of the vehicle, e. g. more than 4 and less than 10 seconds. The control unit may comprise a clock to measure the period of time. During this period of time, the control unit receives the signals from the wheel angle sensor determining the steering angle of the steered wheel. When the received signals of the wheel angle sensor represent smaller steering angles, the control unit may estimate a higher driving speed of the vehicle since a higher driving speed may not cause a driving instability of the vehicle in case of smaller steering angles. But when the received signals of the wheel angle sensor represent greater steering angles the control unit may estimate a lower driving speed of the vehicle since a higher driving speed may cause a driving instability of the vehicle in case of greater steering angles. Therefore, the control unit may estimate a higher driving speed of the vehicle in case of smaller steering angles in contrast to greater steering angles. Consequently, the control unit may determine a lower maximum steering angle threshold in case of an estimated higher driving speed in contrast to an estimated lower driving speed.

For example, smaller steering angles may be considered to be lower than 5 degree whereas greater steering angles may be considered to be greater than 10 degree.

The at least one sensor may be a steering wheel sensor for determining the turning angle of the steering wheel.

Thus, the at least one sensor is different to a speed sensor for measuring the driving speed of the vehicle. But the control unit may process the turning angle determined by the wheel angle sensor for estimating the driving speed of the vehicle. If the electro-hydraulic steering system comprises the steering wheel sensor and the wheel angle sensor the electro-hydraulic steering system would comprise two dissimilar redundant sensors other than a speed sensor for estimating the driving speed of the vehicle. The at least one sensor may also be configured to determine the turning direction.

The control unit may be configured to determine a change of the turning angle of the steering wheel over a period of time and to estimate the driving speed of the vehicle wherein the driving speed of the vehicle may be the higher, the smaller the change of the turning angle of the steering wheel over a period of time may be.

The control unit may estimate the driving speed of the vehicle in dependence of the turning angle analogously to the estimation of the driving speed in dependence of the steering angle. The period of time may be any time interval. For example, the period of time may delay more than 5 and less than 8 seconds, e. g. for a manual steering operation. In case of an automatic steering operation, the period of time may be a little bit greater compared to a manual operation of the vehicle, e. g. more than 4 and less than 10 seconds. The control unit may comprise a clock to measure the period of time. During this period of time, the control unit receives the signals from the steering wheel sensor determining the turning angle of the steering wheel. When the received signals of the steering wheel sensor represent smaller turning angles the control unit may estimate a higher driving speed of the vehicle since a higher driving speed may not cause a driving instability of the vehicle in case of smaller turning angles. But when the received signals of the steering wheel sensor represent greater turning angles the control unit may estimate a lower driving speed of the vehicle since a higher driving speed may cause a driving instability of the vehicle in case of greater turning angles. Therefore, the control unit may estimate a higher driving speed of the vehicle in case of smaller turning angles in contrast to greater turning angles. Consequently, the control unit may determine a lower maximum steering angle threshold in case of an estimated higher driving speed in contrast to an estimated lower driving speed.

For example, smaller turning angles may be considered to be lower than 20 degree whereas greater turning angles may be considered to be greater than 40 degree.

The control unit may be configured to determine the maximum steering angle threshold wherein the maximum steering angle threshold may be the lower, the higher the estimated driving speed of the vehicle may be.

Thus, the control unit may determine different maximum steering angle thresholds for different estimated driving speeds of the vehicle. The control unit may adapt the maximum steering angle threshold continuously or stepwise in terms of predefined steps. The control unit may determine higher maximum steering angle thresholds in case of lower driving speeds and vice versa.

The control unit may be configured to limit a fluid volume of the fluid flow provided by the electro-hydraulic valve in dependence of the estimated driving speed of the vehicle.

The hydraulic steering actuator may adjust the steering angle of the steered wheel in dependence of the fluid flow provided by the electro-hydraulic valve. The steering angle may increase when the fluid volume of the fluid flow provided to the hydraulic steering actuator increases. Thus, an increase of the steering angle up to a level that might cause a driving instability of the vehicle can be avoided by limiting the fluid volume to a level that ensures a stable vehicle driving with a driving speed up to the estimated driving speed.

The control unit may be configured to receive a signal from an autonomous driving control system for driving the vehicle automatically wherein the automatic steering demand may be triggered by the signal from the autonomous driving control system.

The autonomous driving control system may communicate with a position determination unit to determine the global position of the vehicle such as a global navigation satellite system (GNSS) receiver or an inertial measurement unit (IMU) or both. The vehicle positions may be used to calculate the driving speed of the vehicle based on two positions determined at different points of time. The autonomous driving control system may additionally comprise an acceleration sensor for sensing accelerations in longitudinal or lateral directions of the vehicle for calculating the driving speed of the vehicle. The autonomous driving control system may process the position signals received by the position determination unit to generate signals for an autonomous operation of the vehicle, for example by means of a guidance system to guide the vehicle along a predefined path. Based on these signals, an automatic steering demand can be triggered by the control unit, for example for controlling the vehicle to follow a curved path.

The control unit may be configured to determine a change of the turning angle of the steering wheel and to control the fluid flow provided by the electro-hydraulic valve for controlling the hydraulic steering actuator connected with the steered wheel to adjust the steering angle of the steered wheel according to the automatic steering angle if the change of the turning angle of the steering wheel stopped.

The operator of the vehicle may surveil an autonomous operation of the vehicle and may intervene at any time to take over manual control of the vehicle. For example, the operator may turn the steering wheel to steer manually and to change the driving direction for leaving the path the vehicle was driving autonomously along. The change of the turning angle of the steering wheel may be sensed by the steering wheel sensor to determine the manual control. As long as the steering system is controlled manually, the control unit may not execute any automatic steering demand to adjust the steering angle according to the automatic steering angle. But the control unit may resume the autonomous operation of the vehicle when the operator has finished his manual intervention. The steering wheel sensor may detect when the turning angle of the steering wheel does not change any more. Then, the steering wheel is not controlled any more by the operator and the control unit may control the steering system automatically again. Optionally, the operator needs to confirm the resumption, e. g. by pressing a button, before the control unit takes control over the steering system again.

For the case that the steering wheel comprises a force feedback actuator for warning the operator, the control unit may ignore any sensed turning angles of the steering wheel which have been initiated by the force feedback actuator to avoid that the actuation of the force feedback actuator unintentionally interrupts the autonomous operation of the vehicle. This case may apply to a manual operation as well as to an autonomous/automatic operation.

The electro-hydraulic steering system may comprise an orbitrol providing a first volumetric displacement wherein the electro-hydraulic valve may be configured to provide a second volumetric displacement being at least one and a half times greater than the first volumetric displacement of the orbitrol.

The orbitrol may be used as a hydraulic actuator connected with the steering wheel to provide a required fluid volume to the hydraulic steering actuator to adjust the steering angle of the steered wheel according to the turning angle of the steering wheel. The volume of fluid which is provided per revolution of the orbitrol defines the volumetric displacement of the orbitrol. The volume flow is defined by the volumetric displacement per time.

The fluid volume provided by the orbitrol to the hydraulic steering actuator may be manipulated by the electro-hydraulic valve. For example, the electro-hydraulic valve may increase the fluid volume provided to the hydraulic steering actuator. Since the second volumetric displacement provided by the electro-hydraulic valve can be greater than the first volumetric displacement provided by the orbitrol, the electro-hydraulic valve may have a better performance than the orbitrol to improve the overall performance of the steering system. The improved performance may result in an enhanced steering control of the vehicle if the vehicle drives for example in an agricultural field.

The control unit may be configured to limit the second volumetric displacement to a value corresponding to the first volumetric displacement of the orbitrol.

Thus, the orbitrol and the electro-hydraulic valve may have the same performance for controlling the hydraulic steering actuator.

The control unit may be configured to determine if the vehicle may be driving on-road or off-road and to limit the second volumetric displacement if the vehicle may be driving on-road.

The control unit may process the position signals received from the position determination unit and compare the position signals with a map to determine if the vehicle is positioned on a road or off-road as for example in an agricultural field. When the vehicle drives on-road, the performance of the orbitrol and the electro-hydraulic valve may be the same whereas the performance of the electro-hydraulic valve may be enhanced compared to the orbitrol when the vehicle drives off-road.

Another aspect includes a method of limiting the steering angle of an electro-hydraulic steering system of a vehicle comprising steps for estimating a driving speed of the vehicle, determining a maximum steering angle threshold in dependence of the estimated driving speed of the vehicle, determining an automatic steering angle in response to an automatic steering demand, controlling a fluid flow provided by an electro-hydraulic valve of the electro-hydraulic steering system for controlling a hydraulic steering actuator connected with a steered wheel to adjust a steering angle of the steered wheel according to the automatic steering angle and limiting the automatic steering angle to the maximum steering angle threshold.

As described above, the control unit may be configured to execute each single method step so that the method may be executed by the control unit. The maximum steering angle threshold may be set to a value that ensures vehicle stability in dependence of the estimated driving speed. Since maximum steering angle threshold limits the automatic steering angle according to the driving speed, a driving instability of the vehicle can be avoided.

The method may comprise a step for determining the steering angle of the steered wheel over a period of time and estimating the driving speed of the vehicle wherein the driving speed of the vehicle may be the higher, the smaller the steering angle of the steered wheel over the period of time may be.

Smaller steering angles may allow higher driving speeds than greater steering angles without causing a potential driving instability. Thus, the control unit may enable a higher driving speed for autonomous operation of the vehicle on the one hand. But on the other hand, the control unit may reduce the maximum steering angle threshold for a stronger limitation of the automatic steering angle to avoid a driving instability in case of higher driving speeds.

The method may comprise steps for determining a change of the steering angle of the steered wheel over a period of time and estimating the driving speed of the vehicle wherein the driving speed of the vehicle is the higher, the smaller the change of the steering angle of the steered wheel over the period of time is.

A smaller change of the steering angle may allow higher driving speeds than a greater change of the steering angle without causing a potential driving instability. Thus, the control unit may enable a higher driving speed for autonomous operation of the vehicle on the one hand. But on the other hand, the control unit may reduce the maximum steering angle threshold for a stronger limitation of the automatic steering angle to avoid a driving instability in case of higher driving speeds.

The method may comprise steps for determining a turning angle of the steering wheel, determining a change of the turning angle of the steering wheel over a period of time and estimating the driving speed of the vehicle wherein the driving speed of the vehicle may be the higher, the smaller the change of the turning angle of the steering wheel over the period of time may be.

A smaller change of the turning angle of the steering wheel may result in a smaller steering angle of the steered wheel. Thus, the control unit may enable a higher driving speed for autonomous operation of the vehicle in case of smaller changes of the turning angle. But the control unit may reduce the maximum steering angle threshold for a stronger limitation of the automatic steering angle to avoid a driving instability in case of higher driving speeds.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Several aspects of the invention will now be described, by way of example only, with reference to the accompanying drawings, in which:

FIG. 1 illustrates an exemplary block diagram of a vehicle.

FIG. 2 illustrates schematically an electro-hydraulic steering system of the vehicle.

FIG. 3 illustrates schematically a signal flow diagram.

FIG. 4 illustrates schematically a signal flow diagram.

FIG. 5 illustrates a flow chart of a method.

### DETAILED DESCRIPTION

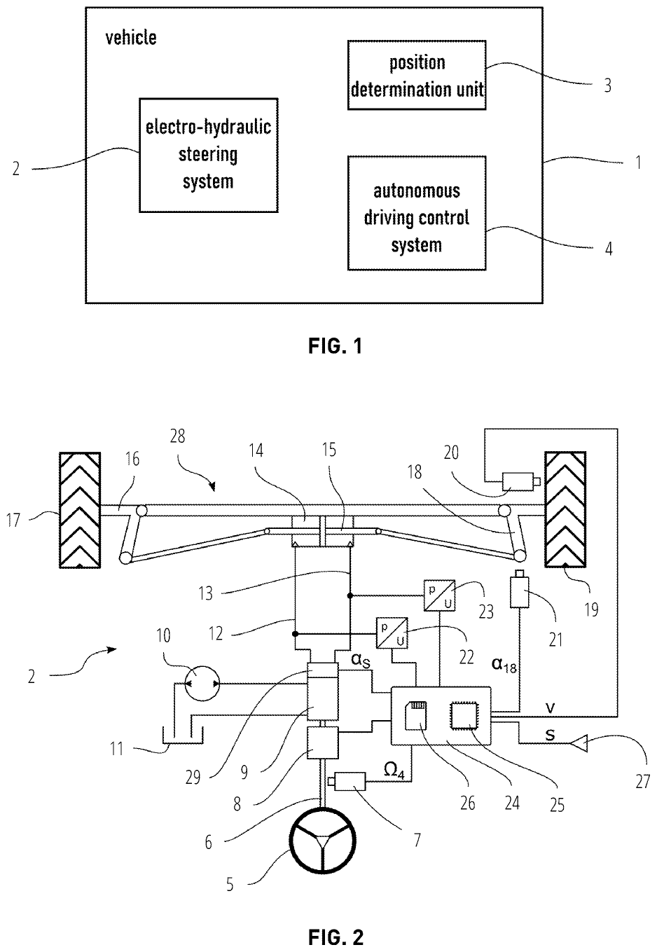

FIG. 1 represents a vehicle 1 in terms of an exemplary block diagram. The vehicle 1 may be any vehicle as for example an agricultural vehicle such as a tractor, a harvester, a sprayer, etc. or any other type of a vehicle. The vehicle 1 comprises an electro-hydraulic steering system 2 as also shown in FIG. 2 for adapting a driving direction of the vehicle 1. A position determination unit 3 is also part of the vehicle 1. The position determination unit 3 may be a global navigation satellite system (GNSS) receiver to receive position signals and time stamps to determine an absolute position of the vehicle 1 at a specific point of time. The GNSS may be GPS or GLONASS, for example. The vehicle positions may be used to calculate the driving direction and the driving speed of the vehicle 1 based on two positions determined at different points of time. The position determination unit 3 may comprise an inertial measurement unit (IMU) comprising acceleration sensors for sensing accelerations in longitudinal and/or lateral directions of the vehicle 1 to determine the position, the driving direction and the speed of the vehicle 1 independently from GNSS signals.

Additionally, the vehicle 1 comprises an autonomous driving control system 4 for enabling an autonomous operation of the vehicle 1. The electro-hydraulic steering system 2, the position determination unit 3 and the autonomous driving control system 4 are connected with each other to exchange signals. Thus, the autonomous driving control system 4 can communicate with the position determination unit 3 to receive the global position at a specific point of time, the speed and the driving direction of the vehicle 1. The autonomous driving control system 4 processes the signals received by the position determination unit 3 to generate signals for an autonomous operation of the vehicle 1, for example by means of a guidance system to guide the vehicle 1 along a predefined path. The signals for an autonomous operation may comprise signals to control the electro-hydraulic steering system 2 that are sent from the autonomous driving control system 4 to the electro-hydraulic steering system 2. In response to the signals, the electro-hydraulic steering system 2 is automatically controlled, for example for controlling the vehicle 1 to follow a curved path. Additionally, the autonomous driving control system 4 controls an engine and brakes of the vehicle 1 for adjusting a driving speed of the vehicle 1. I. e., the autonomous driving control system 4 is configured to control an autonomous operation of the vehicle 1.

FIG. 2 depicts exemplarily the electro-hydraulic steering system 2 of the vehicle 1 comprising at least one steered wheel such as the two steered wheels 17 and 19 with an adjustable steering angle (α₁₈). The steering system 2 is configured as an electro-hydraulic, superimposed steering system. The steering system 2 comprises a steering wheel 5 for setting a steering demand in terms of a desired steering angle (i. e. angular position) of the steered wheels 17, 19 and a hydraulic steering actuator operably coupled to the steered wheels 17, 19 to turn the steered wheels 17, 19 in response to the steering demand from the steering wheel 5. The steering wheel 5 is coupled to a steering column 6 which is arranged to transmit rotational movement of the steering wheel 5 to an orbitrol 9. The orbitrol 9 is hydraulically connected to a pump 10, which is arranged to pump hydraulic fluid from a tank 11 to the orbitrol 9. The orbitrol 9 is also connected to the hydraulic steering actuator by a first hydraulic line 12 and a second hydraulic line 13. The hydraulic steering actuator comprises a steering cylinder 14 housing a piston 15. The piston 15 is arranged to move axially within the steering cylinder 14. The piston 15 of the hydraulic steering actuator is coupled to a left steering arm 16 and a right steering arm 18 of a steering arrangement 28 to which the left steered wheel 17 and the right steered wheel 19 are rotatably mounted accordingly. When the piston 15 moves within the steering cylinder 14, the steered wheels 17 and 19 are caused to turn correspondingly for changing the driving direction of the vehicle 1.

Further, the electro-hydraulic steering system 2 comprises an electric motor 8 and an electro-hydraulic valve 29 electrically connected with a control unit 24 for receiving control signals. The electro-hydraulic valve 29 is arranged between the orbitrol 9 and the hydraulic steering actuator and can be electrically actuated by the control unit 24 to control the delivery of fluid from the orbitrol 9 to the hydraulic steering actuator. By controlling output of fluid to the hydraulic steering actuator via the electro-hydraulic valve 29, it is possible to adjust the volume flow of the fluid supplied by the orbitrol 9 to the first and second hydraulic lines 12 and 13 and thereby control the steering angle of the steered wheels 17 and 19 via the piston 15. Additionally, the electro-hydraulic valve 29 can be controlled by the control unit 24 to increase or decrease the volume flow of pressurized fluid supplied by the orbitrol 9 to the hydraulic steering actuator to turn the steered wheels 17 and 19 according to a variable primary steering ratio Rp between the steering wheel 5 and the steered wheels 17 and 19.

A first volumetric displacement of the orbitrol 9 defines the amount of fluid that can be delivered by the orbitrol 9 per each revolution of the orbitrol 9 to the hydraulic steering actuator. The greater the first volumetric displacement of the orbitrol 9 is, the less revolutions of the orbitrol 9 (and the less rotations of the steering wheel 5) are needed to steer the steered wheels 17 and 19 from a full left lock to a full right lock or vice versa. I. e. the performance of the steering system 2 depends on the first volumetric displacement of the orbitrol 9.

Next to the first volumetric displacement, the electro-hydraulic valve 29 provides a second volumetric displacement. The second volumetric displacement is adjustable by the control unit 24 and can be increased to a volume being at least one and a half times greater than the first volumetric displacement. The additional fluid of the electro-hydraulic valve 29 can be delivered in addition to the fluid delivered by the orbitrol 9 when the steering wheel 5 is rotated by an operator. Due to the additional fluid of the electro-hydraulic valve 29, the number of rotations needed to steer the steered wheels 17 and 19 from a full left lock to a full right lock can be reduced. Thus, the performance of the steering system 2 can be improved when the electro-hydraulic valve 29 delivers fluid to the hydraulic steering actuator in addition to the fluid delivered by the orbitrol 9. The amount of fluid delivered by the electro-hydraulic valve 29 depends on the adjustment of the second volumetric displacement by the control unit 24 and can vary from zero to the full volume of the second volumetric displacement.

The electric motor 8 is configured to selectively control actuation of the orbitrol 9 in order to steer the vehicle 1. The control unit 24 may receive signals from an interface 27 connected with the control unit 24. For example, the control unit 24 receives signals from the autonomous driving control system 4 or the position determination unit 3 via the interface 27. The interface 27 can also comprise a wireless interface for transmitting radio signals, for example radio signals sent from a remote user interface due to an operator interaction. Based on the signals received via the interface 27, the control unit 24 can control the electric motor 8. In response to the control signals of the control unit 24, the motor 8 actuates the orbitrol 9 in order to provide remote control of the electro-hydraulic steering system 2, or automated steering guidance. The motor 8 can alternatively/additionally be arranged to provide a haptic force feedback function to the steering wheel 5, e. g. to vibrate the steering wheel 5 to provide feedback such as a warning.

The steering system 2 includes a speed sensor 20 which is arranged to sense the speed of the vehicle 1 and to send a speed signal indicating the sensed speed to the control unit 24. The steering system 2 also comprises a steering wheel sensor 7 and a wheel angle sensor 21. The steering wheel sensor 7 is arranged to continuously sense the angular position of the steering wheel 5, and to send data representing turning angle (Ω₄) of the steering wheel 5 to the control unit 24. The wheel angle sensor 21 continuously senses an angular position (α₁₈) of at least one of the steered wheels 17 and 19, and sends the sensed information to the control unit 24. Pressure sensors 22 and 23 of the electro-hydraulic steering system 2 are arranged to sense the pressure of the hydraulic fluid in the hydraulic lines 12 and 13 and to communicate the sensed pressure values to the control unit 24. For example, the control unit 24 may use the pressure signals of the pressure sensors 22, 23 for controlling the motor 8 to apply a force feedback to the steering wheel 5.

As can be seen in FIG. 2, the control unit 24 comprises a controller 25 and a memory 26. The control unit 24 may receive and send signals or data via several electric connections such as the interface 27. The controller 25 may store the data or signals received by the control unit 24 in the memory 26. For example, the turning angle (Ω₄) of the steering wheel 5 and the angular position ais received from the steering wheel sensor 7 and the wheel angle sensor 21 can be stored in the memory 26. The memory 26 may contain additional data or executable computer program products, for example in terms of a computer-implemented method, that may be retrieved, processed or executed by the controller 25. Data or signals resulting from the processing of data or signals or from the execution of a computer program product may be stored in the memory 26 or sent to any interface by the controller 25. The controller 25 is configured to receive and process sensor signals/data, including signals/data representative of an angular position of the steering wheel 5, an angular position of the steered wheels 17 and 19, and the driving speed of the vehicle 1.

The control unit 24 is an ECU comprising one or more controllers 25, input/output (I/O) interface(s), and the memory 26, all coupled to one or more data busses. The memory 26 may include any one or a combination of volatile memory elements (e. g., random-access memory (RAM), such as DRAM, and SRAM, etc.) and non-volatile memory elements (e. g., ROM, hard drive, tape, CD-ROM, etc.). The memory 26 may store a native operating system, one or more native applications, emulation systems, or emulated applications for any of a variety of operating systems and/or emulated hardware platforms, emulated operating systems, etc. It should be appreciated by one having ordinary skill in the art that additional or fewer software modules (e. g., combined functionality) may be employed in the memory 26 or additional memory. In some embodiments, a separate storage device may be coupled to the data bus, such as a persistent memory (e. g., optical, magnetic, and/or semiconductor memory and associated drives).

The controller 25 may be embodied as a custom-made or commercially available processor, a central processing unit (CPU) or an auxiliary processor among several processors, a semiconductor based microprocessor (in the form of a microchip), a macro processor, one or more application specific integrated circuits (ASICs), a plurality of suitably configured digital logic gates, and/or other well-known electrical configurations comprising discrete elements both individually and in various combinations to coordinate the overall operation of the control unit 24.

In manual use, the steering wheel 5 is rotated by an operator to generate a steering demand for steering the steered wheels 17 and 19. The rotational movement of the steering wheel 5 is transmitted to the orbitrol 9. The orbitrol 9 has a first fluid output connected to the first hydraulic line 12 and a second fluid output connected to the second hydraulic line 13. Fluid is supplied by the pump 10 from the tank 11 to the first and second hydraulic lines 12 and 13 in order to steer the steered wheels 17 and 19 via the hydraulically controlled piston 15. The hydraulic lines 12 and 13 are coupled to the steering cylinder 14 so that volume flow transported in the hydraulic lines 12, 13 determines the position of the piston 15. Movement of the piston 15, in response to a change in pressure difference between the hydraulic lines 12 and 13, exerts a steering force on the steering arms 16 and 18 of the steering arrangement 28 thereby turning the steered wheels 17 and 19.

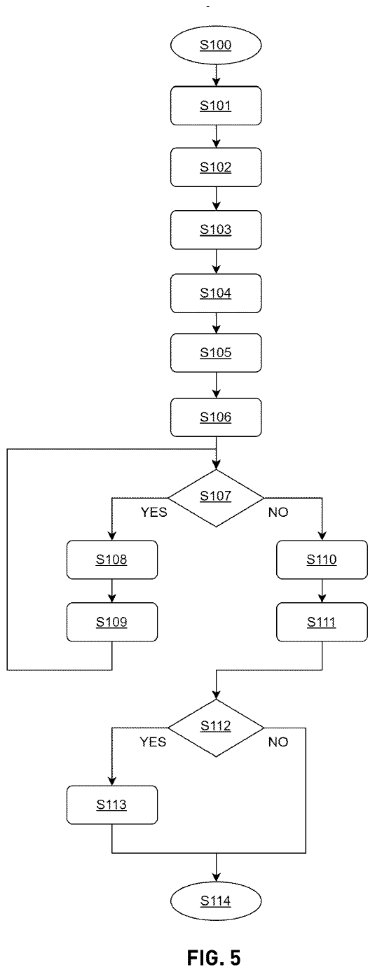

In automatic control, e. g. for an autonomous operation of the vehicle 1, the control unit 24 processes signals, e. g. signals received from the autonomous driving control system 4 and/or the position determination unit 3, and executes a method as depicted in a flow chart of FIG. 5 to control the steering angles of the steered wheels 17 and 19 automatically.

The method may be a computer-implemented method stored as a computer program product in the memory 26 of the control unit 24. The control unit 24 is configured to carry out the method that may be executed by the controller 25. The method is described by way of example of several steps without any restriction in respect of that steps. I. e. the number or the order of steps may be adapted, for example single steps may be excluded and/or added and executed earlier or later than described. The method starts with step S100 and proceeds to step S101.

At step S101, the control unit 24 determines the steering angle (α₁₈) of the at least one steered wheel 17, 19 over a period of time. For example, the period of time may delay more than 5 and less than 8 seconds, e. g. for a manual steering operation. In case of an automatic steering operation, the period of time may be a little bit greater compared to a manual operation of the vehicle, e. g. more than 4 and less than 10 seconds. During this period of time, the wheel angle sensor 21 senses the steering angle (α₁₈) multiple times and sends corresponding steering angle signals to the control unit 24. The control unit 24 processes the received steering angle signals and may determine values of the steering angles (α₁₈) and a rate of change of the steering angles (Δα₁₈).

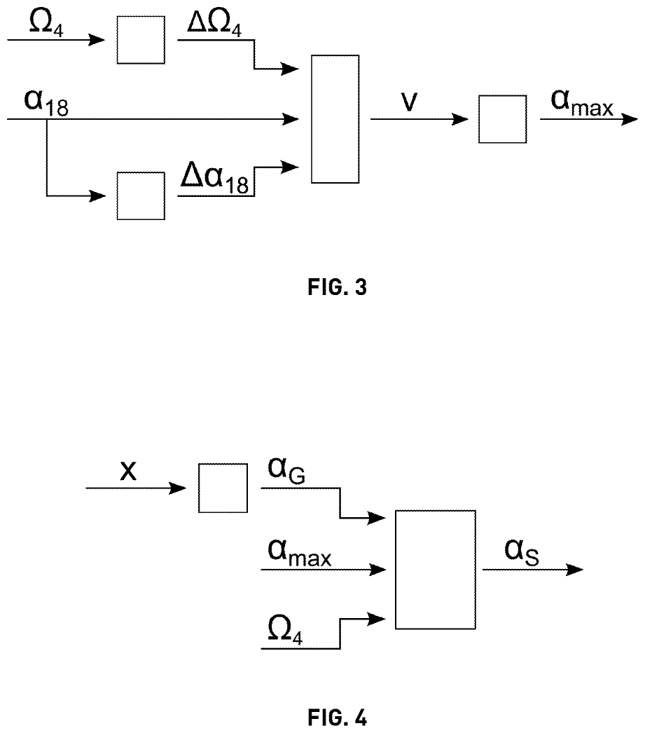

Alternatively or additionally, the method proceeds to step S102 and the control unit 24 determines a change of the turning angle (Ω₄) of the steering wheel 5 over a period of time. E. g., the period of time may be the same as the period of time of step S101. During this period of time, the steering wheel sensor 7 senses the turning angle (Ω₄) of the steering wheel 5 multiple times and sends corresponding turning angle signals to the control unit 24. The control unit 24 processes the received turning angle signals and determines the change of the turning angle (ΔΩ₄) based on at least two turning angles sensed at different points of time as schematically depicted in a signal flow diagram of FIG. 3. The control unit 24 may also determine a rate of change of the turning angle (Ω₄).

Then, the method proceeds to step S103 and the control unit 24 estimates a driving speed (v) of the vehicle 1. The driving speed (v) is estimated based on the steering angle (α₁₈), the change of the steering angle (Δα₁₈) or the change of the turning angle (AQ₄) or any combination of these signals as schematically depicted in the signal flow diagram of FIG. 3. The estimated driving speed (v) of the vehicle 1 is the higher, the smaller the steering angle (α₁₈) of the at least one steered wheel 17, 19 over a period of time is. Vice versa, the estimated driving speed (v) of the vehicle 1 is the lower, the greater the steering angle (α₁₈) of the at least one steered wheel 17, 19 over a period of time is since the probability of a driving instability at a certain speed value increases with increasing steering angles (α₁₈). Analogously, the estimated driving speed (v) of the vehicle 1 is the higher, the smaller the change of the steering angle (Δα₁₈) of the at least one steered wheel 17, 19 over a period of time is. Vice versa, the estimated driving speed (v) of the vehicle 1 is the lower, the greater the change of the steering angle (Δα₁₈) of the at least one steered wheel 17, 19 over a period of time is since the probability of a driving instability at a certain speed value increases with a greater change of the steering angle (Δα₁₈). The control unit 24 may estimate the driving speed (v) by means of a lookup table or a formula stored in the memory 26 under consideration that the estimated driving speed (v) would not cause a driving instability of the vehicle 1 in respect of the determined steering angle (α₁₈) and/or the change of the steering angle (Δα₁₈).

Analogously, the estimated driving speed (v) of the vehicle 1 is the higher, the smaller the change of the turning angle (ΔΩ₄) of the steering wheel 5 over a period of time is. Vice versa, the estimated driving speed (v) of the vehicle 1 is the lower, the greater the change of the turning angle (ΔΩ₄) of the steering wheel 5 over a period of time is since the probability of a driving instability at a certain speed value increases with increasing changes of the turning angle (ΔΩ₄). The control unit 24 may estimate the driving speed (v) by means of a lookup table or a formula stored in the memory 26 under consideration that the estimated driving speed (v) would not cause a driving instability of the vehicle 1 in respect of the determined change of the turning angle (ΔΩ₄).

Thus, the driving speed of the vehicle 1 can be estimated without the speed signal of the speed sensor 20 or the position and time signals of the GNSS. I. e., the speed estimation will also work in case of loss of the speed signal since the wheel angle sensor 21 and/or the steering wheel sensor 7 are used as an alternative sensor to the speed sensor for estimating the driving speed of the vehicle 1.

The method proceeds to step S104 and the control unit 24 determines a maximum steering angle threshold (αₘₐₓ). The maximum steering angle threshold (αₘₐₓ) limits an increase of the steering angle of the at least one steered wheel 17, 19 over the maximum steering angle threshold (αₘₐₓ). The maximum steering angle threshold (αₘₐₓ) may be exceeded by a manual intervention of an operator when he turns the steering wheel 5 but not by an automatic control of the steering system 2.

The maximum steering angle threshold (αₘₐₓ) is determined in dependence of the estimated driving speed (v) of the vehicle 1 as schematically depicted in the signal flow diagram of FIG. 3. The maximum steering angle threshold (αₘₐₓ) is the lower, the higher the estimated driving speed of the vehicle (1) is and vice versa. The control unit 24 may estimate the maximum steering angle threshold (αₘₐₓ) by means of a lookup table or a formula stored in the memory 26 under consideration that a steering angle of the at least one steered wheel 17, 19 corresponding to the maximum steering angle threshold (αₘₐₓ) would not cause a driving instability of the vehicle 1 in respect of the estimated driving speed (v) of the vehicle 1.

The method proceeds to step S105 and the control unit 24 receives a signal from the autonomous driving control system 4 for driving the vehicle 1 automatically. For example, the autonomous driving control system 4 control the vehicle 1 to guide the vehicle 1 automatically along a predefined path in an agricultural field. The autonomous driving control system 4 may communicate with the position determination unit 3 to check if the vehicle 1 is following the path and determine correction signals when the vehicle 1 is leaving the path. Thus, the autonomous driving control system 4 will trigger an automatic steering demand and sends a corresponding signal to the control unit 24 if an automatic steering control is necessary to keep the vehicle 1 on the path.

The method proceeds to step S106 and the control unit 24 receives the signals sent from the autonomous driving control system 4. In response to the automatic steering demand (x), the control unit 24 determines an automatic steering angle (α_{G}) as schematically depicted in the signal flow diagram of FIG. 4. The automatic steering angle (α_{G}) may correspond to the steering angle of the at least one steered wheel 17, 19 to keep the vehicle 1 on the path, for example to guide the vehicle 1 along a curved path. Alternatively, the vehicle 1 may operate in a follower mode to automatically follow a leader vehicle. Then, the automatic steering angle (α_{G}) may correspond to a steering angle of the at least one steered wheel 17, 19 to follow the track of the leader vehicle.

The method proceeds to step S107 and the control unit 24 checks whether the received signal of the steering wheel sensor 7 indicates a manual operation of the steering wheel 5.

A manual operation of the steering wheel 5 can be determined by the control unit 24 if the turning angle (Ω₄) of the steering wheel 5 changes wherein the change of the turning angle (Ω₄) has not been caused by the motor 8. In this case, the method proceeds to step S108 and the control unit 24 determines a steering signal (αₛ) for adjusting the steering angle (α₁₈) of the at least one steered wheel 17, 19 according to the turning angle (Ω₄) sensed by the steering wheel sensor 7 as schematically depicted in the signal flow diagram of FIG. 4.

Then, the method proceeds to step S109 and the control unit 24 sends the steering signal (αₛ) to the electro-hydraulic valve 29 to control the fluid flow provided by the electro-hydraulic valve 29. The fluid transferred from the electro-hydraulic valve 29 to the hydraulic steering actuator (14, 15) controls the position of the piston 15 to adjust the steering angle (α₁₈) of the at least one steered wheel 17, 19 according to the steering signal (αₛ).

Then, the method steps back to step S107.

If the control unit 24 does not determine a manual operation of the steering wheel 5 at step S107, for example when the manual operation of the steering wheel 5 has been stopped, the method proceeds to step S110 and the control unit 24 compares the automatic steering angle (α_{G}) with the maximum steering angle threshold (αₘₐₓ). If the automatic steering angle (α_{G}) exceeds the maximum steering angle threshold (αₘₐₓ), the control unit 24 sets the steering signal (αₛ) according to the maximum steering angle threshold (αₘₐₓ) determined at step S104 as schematically depicted in the signal flow diagram of FIG. 4. Thus, the automatic steering angle (α_{G}) is limited to the maximum steering angle threshold (αₘₐₓ). If the automatic steering angle (α_{G}) is below the maximum steering angle threshold (αₘₐₓ), the control unit 24 sets the steering signal (αₛ) according to the automatic steering angle (α_{G}) as schematically depicted in the signal flow diagram of FIG. 4. Then, no limitation of the automatic steering angle (α_{G}) is necessary.

Thereafter, the method proceeds to step S111 and the control unit 24 sends the steering signal (αₛ) to the electro-hydraulic valve 29 to control the fluid flow provided by the electro-hydraulic valve 29. Since the steering signal (αₛ) may be limited by the maximum steering angle threshold (αₘₐₓ) depending on the estimated driving speed (v) of the vehicle 1 (see FIG. 3), the fluid volume of the fluid flow provided by the electro-hydraulic valve 29 may be limited by control unit 24 also in dependence of the estimated driving speed (v) of the vehicle 1. The fluid transferred from the electro-hydraulic valve 29 to the hydraulic steering actuator (14, 15) controls the position of the piston 15 to adjust the steering angle (α₁₈) of the at least one steered wheel 17, 19 according to the steering signal (αₛ).

Optionally, the method proceeds to step S112 and the control unit 24 determines whether the vehicle 1 is driving on-road or off-road. For example, the control unit 24 receives the position signal from the position determination unit 3 and checks the position of the vehicle 1 against a map comprising road information. When the vehicle position matches with a road the control unit 24 determines that the vehicle 1 drives on-road otherwise off-road.

When the vehicle 1 is driving on-road, the method proceeds to step S113 and the control unit 24 adjusts the second volumetric displacement of the electro-hydraulic valve 29 to limit the second volumetric displacement according to the first volumetric displacement of the orbitrol 9. I. e., the electro-hydraulic valve 29 delivers the same amount of fluid as the orbitrol 9 delivers per revolution.

When the vehicle 1 is driving off-road, the second volumetric displacement of the electro-hydraulic valve 29 is not limited by the control unit 24 so that the steering system 2 may provide an improved performance when the vehicle 1 is driving off-road.

Then, the method proceeds to step S114 and ends. The method may be restarted again by executing step S100.

All references cited herein are incorporated herein in their entireties. If there is a conflict between definitions herein and in an incorporated reference, the definition herein shall control.

LISTING OF DRAWING ELEMENTS

1 vehicle
2 steering system
3 position determination unit
4 autonomous driving control system
5 steering wheel
6 steering column
7 steering wheel sensor
8 motor
9 orbitrol
10 pump
11 tank
12 hydraulic line
13 hydraulic line
14 steering cylinder
15 piston
16 steering arm
17 steered wheel
18 steering arm
19 steered wheel
20 speed sensor
21 wheel angle sensor
22 pressure sensor
23 pressure sensor
24 control unit
25 controller
26 memory
27 interface
28 steering arrangement
29 electro-hydraulic valve

1. An electro-hydraulic steering system for a vehicle comprising:
a steered wheel with an adjustable steering angle (α18);
a steering wheel for demanding a manual steering angle based on a turning angle (Ω4) of the steering wheel;
a control unit connected with an electro-hydraulic valve;
wherein the control unit is configured to
estimate a driving speed of the vehicle;
determine a maximum steering angle threshold (αmax) in dependence of the estimated driving speed of the vehicle;
determine an automatic steering angle (α_{G}) in response to an automatic steering demand;
control a fluid flow provided by the electro-hydraulic valve for controlling a hydraulic steering actuator connected with the steered wheel to adjust the steering angle (α18) of the steered wheel according to the automatic steering angle (αG); wherein
the automatic steering angle (αG) is limited to the maximum steering angle threshold (αmax).

2. The electro-hydraulic steering system of claim 1, comprising
at least one sensor other than a speed sensor for estimating the driving speed of the vehicle.

3. The electro-hydraulic steering system of claim 2, wherein
the at least one sensor is a wheel angle sensor for determining the steering angle (α18) of the steered wheel.

4. The electro-hydraulic steering system of claim 3, wherein the control unit is configured to determine the steering angle (α18) of the steered wheel over a period of time; and
estimate the driving speed of the vehicle, wherein the driving speed of the vehicle is the higher, the smaller the steering angle (α18) of the steered wheel over a period of time is.

5. The electro-hydraulic steering system of claim 2, wherein
the at least one sensor is a steering wheel sensor for determining the turning angle (Ω4) of the steering wheel.

6. The electro-hydraulic steering system of claim 5, wherein the control unit is configured to
determine a change of the turning angle (ΔΩ4) of the steering wheel over a period of time; and
estimate the driving speed of the vehicle; wherein the driving speed of the vehicle is the higher, the smaller the change of the turning angle (ΔΩ4) of the steering wheel over a period of time is.

7. The electro-hydraulic steering system of claim 1, wherein the control unit is configured to
determine the maximum steering angle threshold (αmax); wherein the maximum steering angle threshold (αmax) is the lower, the higher the estimated driving speed of the vehicle is.

8. The electro-hydraulic steering system of claim 1, wherein the control unit is configured to
limit a fluid volume of the fluid flow provided by the electro-hydraulic valve in dependence of the estimated driving speed of the vehicle.

9. The electro-hydraulic steering system of claim 1, wherein the control unit is configured to
receive a signal from an autonomous driving control system for driving the vehicle automatically; wherein
the automatic steering demand is triggered by the signal from the autonomous driving control system.

10. The electro-hydraulic steering system of claim 1, wherein the control unit is configured to
determine a change of the turning angle (Ω4) of the steering wheel; and
control the fluid flow provided by the electro-hydraulic valve for controlling the hydraulic steering actuator connected with the steered wheel to adjust the steering angle (α18) of the steered wheel according to the automatic steering angle (αG) if the change of the turning angle (Ω4) stopped.

11. The electro-hydraulic steering system of claim 1, comprising
an orbitrol providing a first volumetric displacement;
wherein the electro-hydraulic valve is configured to provide a second volumetric displacement being at least one and a half times greater than the first volumetric displacement of the orbitrol.

12. The electro-hydraulic steering system of claim 11, wherein the control unit is configured to
limit the second volumetric displacement to a value corresponding to the first volumetric displacement of the orbitrol.

13. The electro-hydraulic steering system of claim 12, wherein the control unit is configured to
determine if the vehicle is driving on-road or off-road; and
to limit the second volumetric displacement if the vehicle is driving on-road.

14. A method for limiting the steering angle of an electro-hydraulic steering system of a vehicle, comprising:
estimating a driving speed of the vehicle;
determining a maximum steering angle threshold (αmax) in dependence of the estimated driving speed of the vehicle;
determining an automatic steering angle (αG) in response to an automatic steering demand;
controlling a fluid flow provided by an electro-hydraulic valve of the electro-hydraulic steering system for controlling a hydraulic steering actuator connected with a steered wheel to adjust a steering angle (α18) of the steered wheel according to the automatic steering angle (αG); and
limiting the automatic steering angle (αG) to the maximum steering angle threshold (αmax).

15. The method of claim 14, comprising:
determining the steering angle (α18) of the steered wheel over a period of time; and
estimating the driving speed of the vehicle, wherein the driving speed of the vehicle is the higher, the smaller the steering angle (α18) of the steered wheel over the period of time is.

16. The method of claim 14, comprising:
determining a change of the steering angle (Δα18) of the steered wheel over a period of time; and
estimating the driving speed of the vehicle, wherein the driving speed of the vehicle is the higher, the smaller the change of the steering angle (Δα18) of the steered wheel over the period of time is.

17. The method of claim 14, comprising:
determining a turning angle (Ω4) of the steering wheel;
determining a change of the turning angle (Ω4) of the steering wheel over a period of time; and
estimating the driving speed of the vehicle; wherein the driving speed of the vehicle is the higher, the smaller the change of the turning angle (Ω4) of the steering wheel over the period of time is.
